(19) United States
(12) Patent Application Publication
(10) Pub. No.: US 2025/0183737 A1
(43) Pub. Date: Jun. 5, 2025

(54) PERMANENT MAGNET TEMPERATURE CONTROL TO REDUCE LOSSES

(71) Applicant: GM GLOBAL TECHNOLOGY OPERATIONS LLC, Detroit, MI (US)

(72) Inventors: Vincent Fedida, Shanghai (CN); Chengwu Duan, Shanghai (CN)

(73) Assignee: GM GLOBAL TECHNOLOGY OPERATIONS LLC, Detroit, MI (US)

(21) Appl. No.: 18/404,252

(22) Filed: Jan. 4, 2024

(30) Foreign Application Priority Data
Dec. 1, 2023 (CN) 202311638571.3

(51) Int. Cl. H02K 1/2726; B60K 11/02; B60L 15/08; H02K 1/02; H02K 9/19

(52) U.S. Cl. CPC H02K 1/2726; B60K 11/02; H02K 1/02; H02K 9/19; B60L 15/08; H02K 2209/00

(57) ABSTRACT

An electric drive system includes a permanent magnet motor, rotor magnets connected to a rotor thereof, a heating source such as a resistive heating element connected to the rotor magnets, and an electronic controller. The controller selectively heats the rotor magnets via the heating source during a predetermined low-load/high-speed operating mode of the electric drive system. The controller may preemptively cool the rotor magnets, e.g., via pre-chilled electrical coolant, in response to a predicted or impending high-load/low-speed operating mode. The heating element may include a positive temperature coefficient heating element disposed between a rotor yoke and the rotor magnets. A method includes detecting the low-load/high-speed operating mode, and selectively heating the rotor magnets via a heating source during such a mode. A motor vehicle includes road wheels and the electric drive system, the motor of which powers one or more of the road wheels.

### CROSS-REFERENCE TO RELATED APPLICATIONS

This application claims the benefit of priority to Chinese Patent Application CN202311638571.3 filed on Dec. 1, 2023, which is hereby incorporated by reference in its entirety.

### INTRODUCTION

The present disclosure relates to methods and systems for reducing losses in an electric drive system having a permanent magnet-type motor (PM motor).

Advanced hybrid-electric and full-electric/battery electric vehicles include one or more electric traction motors. Each traction motor is energized by the controlled discharge of a high-energy battery pack, e.g., a lithium-ion propulsion battery pack or one having another application-suitable battery chemistry. A PM motor is a particular motor construction in which physical magnets are mounted to or embedded within the motor's rotor structure. The permanent magnets of the rotor (“rotor magnets”) are constructed from rare earth materials such as neodymium or samarium-cobalt, from ferrous materials such as ferrite, or from another high-remanence material to enable the rotor to generate and maintain a strong magnetic field. Such rotor magnets are typically cooled during their operation, e.g., via circulation of air or cooling oil/electrical coolant. This action allows the rotor magnets to support high-torque operating modes, and to provide high coercivity suitable for mitigating demagnetization of the rotor magnets.

### SUMMARY

Disclosed herein are an electric drive system having a permanent magnet (PM) motor of the type noted above, and to related control strategies for selectively heating permanent magnets of the rotor (“rotor magnets”) during predetermined low-load operating modes. For example, the electric drive system may be used as part of a motor vehicle in which the PM motor is configured as a traction motor, e.g., onboard a hybrid electric vehicle or a full electric/battery electric vehicle, or of a train, boat, aircraft, or another electrically-driven mobile platform, or as part of a stationary powerplant. Solely for illustrative consistency, the electric drive system is described hereinafter as being used onboard a motor vehicle. In such an implementation, a load driven by the PM motor may include one or more road wheels, without limiting the present teachings to such an embodiment.

The electric drive system in accordance with an embodiment includes a PM motor having a rotor, with one or more rotor magnets connected to the rotor. A heating source is connected to the one or more rotor magnets. An electronic controller in communication with the PM motor and the heating source is programmed to selectively heat the one or more rotor magnets via the heating source during a predetermined low-load/high-speed operating mode of the electric drive system.

The electronic controller may be programmed to predict an impending high-load/low-speed operating mode of the PM motor, and to preemptively request cooling of the rotor magnets via a cooling source in response to the impending high-load/low-speed operating mode.

The rotor magnets may be constructed of rare earth materials or of a ferrous material, e.g., ferrite, in different constructions of the PM motor.

The heating source in one or more configurations includes a resistive heating element. For example, the resistive heating element may include a positive temperature coefficient (PTC) heating element disposed between a rotor yoke and the rotor magnets of the rotor.

The heating source may optionally include a supply of pre-heated electrical coolant. The rotor may include a rotor shaft defining an axial fluid passage therein that is configured to conduct the pre-heated electrical coolant through the rotor shaft for heating the rotor magnets.

In one or more implementations of the present teachings, an inverter circuit of the electric drive system is connected to the PM motor. The electronic controller in such an embodiment may be configured to command pulse width modulation (PWM) harmonics via the inverter circuit as part of the heating source to thereby generate an eddy current within the rotor magnets. This action occurs at a level suitable for heating the rotor magnets.

The present disclosure also includes a method for selectively heating a PM motor of the above-summarized electric drive system. An embodiment of the method includes detecting a predetermined low-load/high-speed operating mode of the electric drive system via an electronic controller, and then selectively heating the rotor magnets during the predetermined low-load/high-speed operating mode via a heating source using the electronic controller. The method may include predicting an impending high-load/low-speed operating mode of the electric drive system via the electronic controller, and preemptively cooling the rotor magnets in response to the impending high-load/low-speed operating mode via a cooling source using the electronic controller.

A motor vehicle is also disclosed herein, which in a representative construction includes a vehicle body, a plurality of road wheels connected to the vehicle body, and an electric drive system. The electric drive system may include a PM motor having a rotor connected to one or more of the road wheels, a plurality of rotor magnets connected to the rotor, a PTC heating element disposed between the rotor yoke and the rotor magnets, and an electronic controller. The electronic controller is configured to selectively heat the rotor magnets via the PTC heating element during a predetermined low-load/high-speed operating mode of the electric drive system.

The electronic controller may predict an impending high-load/low-speed operating mode of the motor vehicle, and preemptively cool the rotor magnets using pre-chilled electrical coolant, e.g., by requesting circulation of the pre-chilled electrical coolant from an onboard coolant supply, in response to the impending high-load/low-speed operating mode. This action may include commanding circulation of the pre-chilled electrical coolant through the PM motor.

As noted above, the rotor may include a rotor shaft defining an axial fluid passage. Such a passage may be configured to conduct the heated electrical coolant and/or the pre-chilled electrical coolant to heat and/or preemptively cool the rotor magnets, respectively.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 illustrates an electrical system of a representative motor vehicle having a permanent magnet (PM) motor whose rotor magnet temperature is regulated during a low-load “cruise” mode as set forth in detail herein.

FIG. 2 is a time plot of output torque illustrating different heating regions for a representative low-load operating mode of the motor vehicle of FIG. 1.

FIG. 3 illustrates a simplified heating circuit for use with the PM motor of FIG. 1.

FIG. 4 is a side-view illustration of a rotor shaft usable with the PM motor of FIG. 1 in accordance with an aspect of the disclosure.

FIG. 5 is an output torque vs. output speed plot illustrating different temperature control regions, with such regions used as part of the present control strategy.

FIG. 6 is a flow chart describing an embodiment of a method for regulating temperature of the rotor magnets of the PM motor illustrated in FIG. 1.

The present disclosure may be modified or embodied in alternative forms, with representative embodiments shown in the drawings and described in detail below. Inventive aspects of the present disclosure are not limited to the disclosed embodiments. Rather, the present disclosure is intended to cover alternatives falling within the scope of the disclosure as defined by the appended claims.

### DETAILED DESCRIPTION

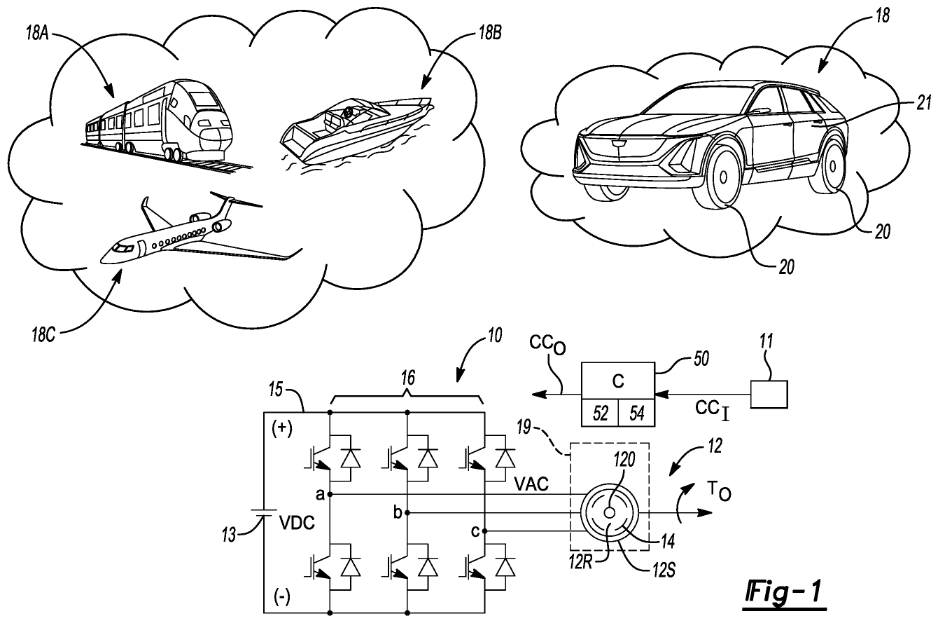

Referring to the drawings, wherein like reference numerals correspond to like or similar components throughout the several Figures, an electric drive system 10 is illustrated in FIG. 1. The electric drive system 10 include one or more rotary electric machines in the form of a permanent magnet (PM) motor 12, e.g., an electric traction motor for use with a motor vehicle 18, or alternatively with a train 18A or another railed vehicle, a boat 18B or another surface or sub-surface watercraft, or an airplane 18C or another fixed-wing or rotor-equipped airborne vehicle. For illustrative clarity and consistency, the electric drive system 10 is described herein as being part of the motor vehicle 18 without limiting applications of the electric drive system 10 to such a host system, or to mobile systems in general.

The present solutions selectively heat a set of rotor magnets 14 of the PM motor 12 during predetermined low-load operating conditions, with the rotor magnets 14 being connected to or integrated with a rotor 12R of the PM motor 12. During such conditions, the PM motor 12 operates at or near a high steady-state output speed, i.e., with little to no acceleration and a relatively low output torque. In keeping with the exemplary vehicular use case, such conditions may coincide with a “cruise mode”, which is typically experienced by a user of the motor vehicle 18 while traveling along a stretch of highway at a desired steady-state speed. Heating the rotor magnets 14 during cruise mode decreases flux density in the rotor 12R of the PM motor 12. Core losses are consequently reduced as a particular benefit of the present strategy.

The approach set forth herein may be used in applications in which the rotor magnets 14 are constructed of rare earth materials such as Neodymium-Iron-Boron (NdFeB) or Samarium-Cobalt (SmCo). In other embodiments, the rotor magnets 14 may be constructed from ferrite as ceramic magnets, or from other ferrous materials. Applications within the electric drive system 10 of FIG. 1 may make use of either construction.

Due to the slow dynamic of rotor cooling, rotor magnets 14 having a rare earth material construction may be used in applications in which the load on the PM motor 12 is largely predictable, such as when the motor vehicle 28 or other host system exhibits repeatable or restricted/high controlled route options. Aspects of the present strategy also include cooling the rotor magnets 14 subsequent to such heating to help avoid demagnetization, with this action occurring in anticipation of the next peak load. Therefore, load anticipation may be a control factor in some implementations. In other embodiments, the rotor magnets 14 may be constructed from ferrous materials such as ferrite to prevent or avoid such demagnetization concerns, which are more commonly associated with rare earth materials. Thus, the particular material composition of the rotor magnets 14 may vary within the scope of the present disclosure.

The PM motor 12 of FIG. 1 also includes a wound stator 12S that circumscribes the rotor 12R, i.e., as a radial flux configuration, although axial flux implementations may also be contemplated within the scope of the disclosure. A rotor shaft 120 of the PM motor 12 is connected to a driven load, which in the exemplary vehicular use case of FIG. 1 may include one or more road wheels 20 disposed with respect to/connected to a vehicle body 21.

The PM motor 12 may include multiple similarly-constructed motors in other embodiments, e.g., for independently or collectively driving one or more of the road wheels 20. Thus, use of the singular PM motor 12 herein is not intended to limit the present teachings to single-motor constructions of the electric drive system 10. Each PM motor 12 is connected to a direct current (DC) voltage bus 15 having positive (+) and negative (−) bus rails. When the PM motor 12 is configured as an alternating current (AC) rotary electric machine as shown, one or more phase windings 17 of the stator 12S are connected to an AC-side of an inverter circuit 16. The PM motor 12 is connected to the DC voltage bus 15 via the inverter circuit 16. As with implementations using multiple PM motors 12, the present disclosure may be extended to multi-inverter topologies in one or more embodiments. Thus, “a” or “an” when used to refer to components of the electric drive system 10 are intended to encompass “one or more unless otherwise specified.

The electric drive system 10 illustrated in FIG. 1 as contemplated herein also includes an electrochemical battery pack 13 connected across the positive and negative bus rails (+, −) of the DC voltage bus 15. The battery pack 13, in this instance configured as a high-voltage traction battery pack 13, e.g., a 300-1000 V lithium-ion or lithium-metal construction suitable for powering drive modes of the motor vehicle 18, is operable for outputting a DC voltage (VDC) to the DC voltage bus 15. The DC voltage (VDC) is converted to an AC voltage (VAC) suitable for energizing the stator 12S of the PM motor 12.

When the stator 12S is energized in this manner, rotation of the rotor 12R ensues to produce an output torque (T_{O}). The output torque (T_{O}) is then directed via the rotor shaft 120 that is coupled to or formed integrally with the rotor 12R. Rotation of the rotor shaft 120 is ultimately imparted to one or more of the road wheels 20, either directly or via intervening drive axles (not shown). The motor vehicle 18 is thus electrically propelled along a road surface in electric or hybrid-electric drive modes. The alternatively constructed vehicles, i.e., the train 18A, 18B, and 18C, may be similarly propelled over or through their respective mediums, i.e., along a track, over/through a body of water, and through the air, respectively.

Still referring to FIG. 1, the electric drive system 10 further includes an electronic control system (“electronic controller”) (C) 50 programmed in software and equipped in hardware, i.e., “configured”, to perform the various monitoring and heating/cooling control processes described below with reference to FIGS. 2-6. As with the PM motor 12 and inverter circuit 16, the electronic controller 50 is illustrated as a single device for illustrative clarity and simplicity. In an actual embodiment, the electronic controller 50 may be implemented as a distributed control system, i.e., one in which multiple processing nodes are in communication with one another from different locations within the electric drive system 10, e.g., as individual motor control processors, transceiver nodes, and the like. Thus, the electronic controller 50 may be implemented as one or more computer devices in various embodiments.

In response to receipt of input signals (CC_{I}) from a sensor suite 11, the electronic controller 50 is configured to execute a method 100 to selectively heat the rotor magnets 14. The sensor suite 11 may include one or more physical sensors or calculation units collectively providing the output torque (T_{O}) and the motor output speed (N_{O}) of the electric traction motor 12, and the rotor magnet temperature (T_{RM}) of the rotor magnets 14. Such values could be calculated or measured and reported by the sensor suite 11 of FIG. 1.

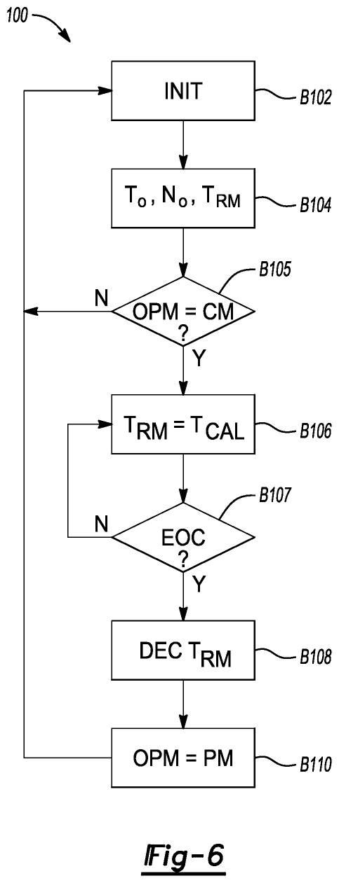

The method 100, an embodiment of which is described below with reference to FIG. 6, may be implemented as one or more algorithms or instruction sets, with the electronic controller 50 ultimately transmitting output signals (CC_{O}) to the PM motor 12 for the purpose of regulating a temperature of the rotor magnets 14. The electronic controller 50 in some embodiments may also selectively and preemptively cool the rotor magnets 14 via an associated thermal management system 19, as illustrated schematically in FIG. 1, such as via a supply of coolant using pumps, heat exchangers, valves, etc.

In addition to heating control signals as described below, the output signals (CC_{O}) may also include ON/OFF state commands or pulse width modulation (PWM) signals for control of the conducting state of individual power switches 160 of the inverter circuit 16. Such PWM signals may also be used in one or more embodiments to generate eddy currents within the rotor 12R to provide or supplement heating of the rotor magnets 14. As appreciated in the art, the power switches 160 may be variously embodied as insulated-gate bipolar transistors (IGBTs), metal-oxide semiconductor field-effect transistors (MOSFETs), bipolar junction transistors (BJTs), etc. Computer-readable code or instructions for implementing the method 100 may be executed by one or more processors 52 and stored in tangible, non-transitory portions of memory 54, with the memory 54 embodying at least one computer-readable storage medium, e.g., magnetic or optical media, CD-ROM, and/or solid-state/semiconductor memory (e.g., various types of RAM or ROM).

The term “controller” and related terms such as control module, module, control, control unit, processor, and similar terms refer to one or various combinations of Application Specific Integrated Circuit(s) (ASIC), Field-Programmable Gate Array (FPGA), electronic circuit(s), central processing unit(s), e.g., microprocessor(s) and associated non-transitory memory component(s) in the form of memory and storage devices (read only, programmable read only, random access, hard drive, etc.). Non-transitory components of the memory 54 are those which are capable of storing machine-readable instructions in the form of one or more software or firmware programs or routines, combinational logic circuit(s), input/output circuit(s) and devices, signal conditioning and buffer circuitry and other components that can be accessed by the processor(s) 52 to provide the described functionality.

Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Routines may be executed at regular intervals, for example about 50-100 microsecond (ms) intervals during ongoing operation. Alternatively, routines may be executed in response to occurrence of a triggering event.

Referring now to FIG. 2, selective heating of the above-described rotor magnets 14 of FIG. 1 is illustrated for an exemplary low-load operating mode of the motor vehicle 18 via a time plot 22. The time plot 22 depicts different heating regions (REG-1: H, REG-2: H) for a representative cruise mode (CM) of the motor vehicle 18 of FIG. 1 over time (t), with time (t) represented in minutes (min). As used herein, “low-load” refers to periods during which the output torque (T_{O}), shown in Newton-meters (Nm) on the vertical axis, drops over a period of time (Δt) from a relatively high torque level (T_{MAX}) to a relatively low and sustained torque level (T_{MIN}).

For instance, commencing at time t₀, arrow 24 represents the decrease in the output torque (T_{O}), with steady-state operation of the PM motor 12 of FIG. 1 commencing at time t₁. Arrow 25 represents such steady-state operation as cruise mode. At time t₃ the output torque (T_{O}) may suddenly increase (arrow 26), e.g., due to an increased torque request from an operator of the motor vehicle 18 of FIG. 1 or an autonomously-generated torque request, with the relatively high torque level again reached at about t₄.

Selective heating of the rotor magnets 14 of FIG. 1 may occur in the first region (REG 1: H) between times t₀ and t₂. At time t₂, the electronic controller 50 may anticipate exiting the cruise mode (arrow 25). For example, the electronic controller 50 may process the input signals (CC_{I}) of FIG. 1 inclusive of the present rotary speed and a user-generated or autonomously-generated torque request to the PM motor(s) 12 to estimate whether an increase in the output torque (T_{O}) and exit from cruise mode (arrow 25) is imminent. The electronic controller 50 of FIG. 1 may also use look-ahead information such as road slope data or topography data, or past drive histories, to determine whether such an increase in the output torque (T_{O}) is likely to be required, such as when traveling toward a steep incline.

Other factors may go into the preemptive cooling determination by the electronic controller 50, such as but not limited to consideration of past drive profiles or the nature of the drive route. As appreciated in the art, some of the representative host systems of FIG. 1, including the train 18A, the airplane 18C, and possibly the boat 18B or certain use cases of the motor vehicle 18 such as autonomous taxis, may travel on well-defined or closed/restricted routes. Thus, the torque/speed trajectories of such host systems may be highly-predictable and repeatable. Thus, at a given point in time the electronic controller 50 may be able to determine, with a high degree of confidence, that the host system is about to exit the low-load operating mode, i.e., cruise mode for the motor vehicle 18 in a typical use case. When this occurs, the electronic controller 50 illustrated in FIG. 1 may discontinue heating the rotor magnets 14 at about t₂, which is the start of the second region (REG 2: C). This action may coincide with optional preemptive cooling the rotor magnets 14, such as via circulation of a suitable electrical coolant within the associated thermal management system 19 illustrated schematically in FIG. 1.

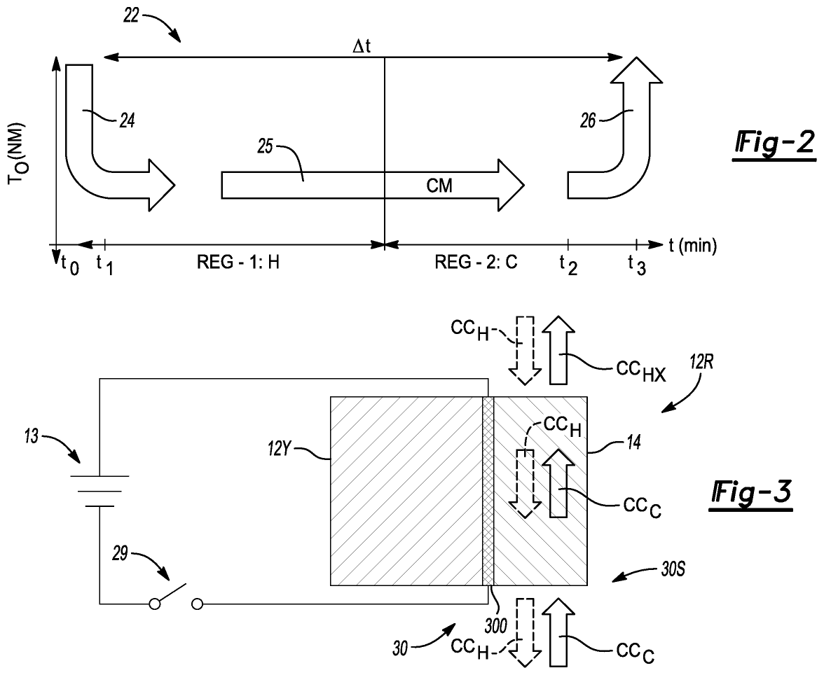

Referring to FIG. 3, selective heating of the rotor magnets 14 by operation of the electronic controller 50 of FIG. 1 in accordance with the present disclosure may proceed in one or more embodiments using a heating circuit 27. Here, the battery pack 13 may be selectively connected to a resistive heating element 30 embedded within or connected to the rotor magnets 14 of the rotor 12R. For instance, the resistive heating element 30 may be disposed between a rotor yoke 12Y and the rotor magnets 14 of the PM motor 12 (see FIG. 1). A switch 29 may be commanded by the electronic controller 50 to open or close, e.g., using the output signals (CC_{O}) to selectively connect or disconnect the battery pack 13 respectively to or from the resistive heating element 30. Alternatively, a secondary battery (not shown), i.e., a battery other than the battery pack 13, may be used as a DC power supply for energizing the resistive heating element 30. Therefore, use of the battery pack 13 for this purpose is exemplary and non-limiting.

In a possible configuration, the resistive heating element 30 may be a positive temperature coefficient (PTC) heating element 300. In such an embodiment, the PTC heating element 300 may be constructed from an application-suitable ceramic material to provide a rapid heating response in an efficient manner that is highly predictable and controllable by the electronic controller 50. Such a solution may enable consistent heat distribution into the rotor magnets 14. In other embodiments, the resistive heating element 30 may include one or more conductive wires passed through or in close proximity to the rotor magnets 14.

The electronic controller 50 may also be configured to command the inverter circuit 16 to generate PWM harmonics to selectively generate an eddy current or currents within the rotor magnets 14. In this instance, the inverter circuit 16 may act as part of a heating source 30S, with the electronic controller 50 thereby heating the rotor magnets 14 at least in part using the eddy currents. The heating source 30S as contemplated herein may therefore include the resistive heating element 30, the inverter circuit 16, and other possible heating devices such as circulation of pre-heated coolant (arrows CC_{H}) to/through the rotor magnets 14.

For optional cooling of the rotor magnets 14, a supply of pre-chilled electrical coolant (arrows CC_{C}), i.e., one having a lower temperature than the rotor magnets 14, may be circulated through and/or around the rotor magnets 14 at the request of the electronic controller 50 to extract heat from the rotor magnets 14. The resulting heated coolant (arrow CC_{HX}) is thereafter exhausted from the rotor magnets 14 and delivered to a downstream heat exchanger (not shown) before possible recirculation back to the rotor magnets 14 as the pre-chilled electrical coolant (arrows CC_{C}).

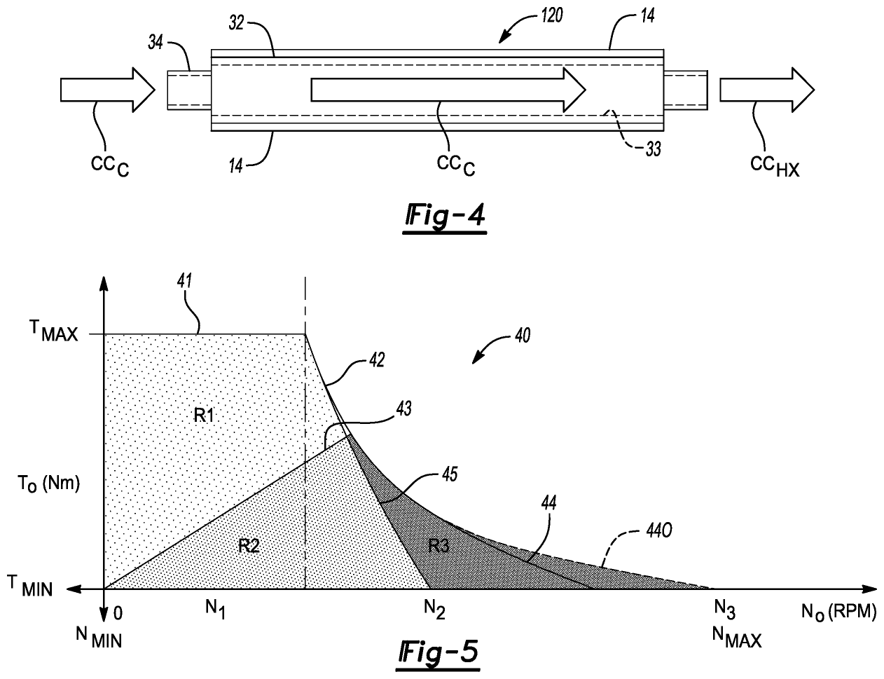

Referring now to FIG. 4, in yet another approach the electronic controller 50 may be configured to preemptively request cooling of the rotor magnets 14 by requesting a circulation of the pre-chilled electrical coolant (arrows CC_{C}) around or through the rotor magnets. The pre-chilled electrical coolant (arrows CC_{C}) could circulate around, near, over, and/or through the rotor magnets 14, e.g., through an axial fluid passage 33 defined by an inner diameter wall 330 of the rotor shaft 120. In a simplified embodiment, the rotor shaft 120 of the PM motor 12 of FIG. 1 may include a shaft body 32 having cylindrical end pieces 34 attached to or formed integrally with the shaft body 32. The pre-chilled electrical coolant (CC_{C}) may be circulated through the axial fluid passage 33 to help cool the rotor shaft 120, and thus the rotor magnets 14 connected thereto or disposed therewithin.

Flow of the pre-chilled electrical coolant (CC_{C}) through the shaft body 32 in this manner extracts heat from the rotor magnets 14. The heated coolant (CC_{HX}) may be thereafter exhausted from the rotor magnets 14 and delivered to a downstream heat exchanger (not shown), as noted above, before possibly being recirculated to the rotor magnets 14. For heating of the rotor magnets 14 the configuration of FIG. 4, the heated coolant (CC_{H}) may be directed through the axial fluid passage 33 to heat the rotor magnets 14. As with the embodiment of FIG. 3, this may occur using the flow of the pre-chilled electrical coolant (CC_{C}) through the axial fluid passage 33 alone or in conjunction with the heating element 30, and/or with other heating sources 30S.

As illustrated by a torque-speed plot 40 in FIG. 5, output torque (T_{O}) in Newton-meters (Nm) and output speed (N_{O}) of the PM motor 12 of FIG. 1 in revolutions per minute (RPM) are shown on the vertical axis and horizontal axis, respectively. In an exemplary event such as launch or at the onset of another rapid acceleration event, output torque (Tₒ) from the electric traction motor 12 is at the relatively high torque level (T_{MAX}) at a low speed N₀, e.g., about 0 RPM or another minimum angular speed (N_{MIN}). As the speed of the PM motor 12 increases to intermediate speed N₁, the output torque (Tₒ) may remain at the relatively high torque level (T_{MAX}) for a period of time, as indicated by the relatively flat trajectory line 41 between nominal speeds N₀ and N₁. At speed N₁, an operator of the motor vehicle 18 or another host system having the PM motor 12 may begin to enter a low-load operating mode, such as the above-noted cruise mode. The speed begins to drop from speed N₁, as indicated by trajectory curve 42, decaying via trajectory curve 44 until a maximum speed at speed N₃, with the maximum speed (N_{MAX}) corresponding to low-load, i.e., minimum torque level (T_{MAX}) of the output torque (T_{O}).

The torque-speed plot 40 is divided into nominal first, second, and third heating regions R1, R2, and R3. The first heating region R1 from speed N₀ and continuing just beyond speed N₁ corresponds to a relatively low PM temperature area, i.e., a region in which the rotor magnets 14 of FIG. 1 are maintained below a calibrated or predetermined lower temperature limit. The first heating region R1 may be separated from the second heating region along a boundary line 43. The second heating region R2 in turn may be separated from the third heating region R3 along boundary line 45, with the boundary lines 43 and 45 being predetermined values that may be recorded in memory 54 of the electronic controller 50 shown in FIG. 1, e.g., in an accessible lookup table.

In the second heating region R2, which corresponds to a relatively light load at lower angular speeds of the PM motor 12 of FIG. 1, the electronic controller 50 may commence heating the rotor magnets 14 of FIG. 1. Such heating may help decrease cogging torque and vibration, increase efficiency, among other potential benefits. As speed of the PM motor 12 increases and the third heating region R3 is entered, the rotor magnets 14 of FIG. 1 may be heated to a lesser degree than in second heating region R2 to extend flux-weakening capability. Precooling time before re-entering the first heating region R1 from the second heating region R2, i.e., before achieving the relatively high torque level (T_{MAX}), depends on the cooling capability of the rotor magnets 14 and the timing of the next peak load. Prediction of peak load by the electronic controller 50 may be possible in certain applications, and would be of particular value when the rotor magnets 14 are constructed of rare earth materials due, e.g., by minimizing the possibility of or preventing demagnetization.

As noted above, materials of construction of the rotor magnets 14 and other components of the PM motor 12 of FIG. 1 greatly influence magnetic performance in a temperature-dependent manner. Heating as set forth herein may be used to reduce core losses and decrease magnetization, with a higher current needed to produce the same torque level. For a rare earth construction of the rotor magnets 14, for instance, heating the rotor magnets 14 from about 80° C. to about 150° C. may reduce core losses by about 20%. This occurs via a corresponding reduction in coercivity, i.e., the ability of the rotor magnet 14 to withstand an applied magnetic field without becoming demagnetized, and remanence, i.e., the strength of the magnetization remaining after removing a strong magnetization force.

Aspects of the disclosure may include pre-cooling the rotor magnets 14 in the event of a sudden load change, as noted above. In a rare earth construction of the rotor magnets 14, there is a higher risk of demagnetization when the load suddenly increases. Thus, thermal management in accordance with the present disclosure may be coordinated by the electronic controller 50 of FIG. 1 when the load is predictive, as the thermal dynamic involved in cooling is relatively slow. Rotor magnets 14 constructed of ferrous materials such as ferrite behave differently, however. Heating of such rotor magnets 14 reduces core losses, as with heating of rare earth magnets, but there is little risk of demagnetization due to sudden load changes. Thus, the precooling time may be shortened relative to precooling of rare earth magnets. As a result, one may use ferrite magnets for the rotor magnets 14 for unpredictable as well as predictable loads, while rare earth PMs may perform optimally for more predictable loads.

Referring now to FIG. 6, the method 100 in accordance with a representative implementation is represented as a series of algorithm code segments or logic blocks for illustrative simplicity. Each of the constituent logic blocks may be executed by the processor(s) 52 of electronic controller(s) 50 of FIG. 1 to enable performance of the associated process steps.

Commencing with block B102 (“INIT”), the electronic controller 50 may initiate in response to a set of entry criteria. Such criteria may be specific to the particular host system for the electric drive system 10 shown in FIG. 1. For instance, if the electric drive system 10 is used onboard the motor vehicle 18, suitable entry conditions may include a key-on cycle indicative of the motor vehicle 18 being in a drive state with the PM motor 12 energized and ready to generate or already generating the output torque (T_{O}). The method 100 then proceeds to block B104.

At block B104 (“T_{O}, N_{O}, T_{RM}”), the electronic controller 50 may receive, measure, or otherwise determine a set of load parameters. Such load parameters may include the output torque (T_{O}), the motor speed (N_{O}) of the PM motor 12, and the rotor magnet temperature (T_{RM}) of the rotor magnets 14. Such values could be calculated or measured and reported by the sensor suite 11 of FIG. 1. The method 100 proceeds to block B105 when the load parameters have been ascertained.

Block B105 (“OPM=CM?”) includes determining if the present operating mode (OPM) corresponds to a predetermined low-load state of the PM motor 12 of FIG. 1. In the representative case of the motor vehicle 18, the low-load state may include cruise mode (CM). The method 100 proceeds to block B106 when the present operating mode corresponds to a predetermined low-load state, and returns to block B102 in the alternative when the present operating mode does not correspond to the predetermined low-load state.

At block B106 (“T_{RM}=T_{CAL}”), the electronic controller 50 may selectively heat the rotor magnets 14 of FIG. 1 until the rotor magnet temperature (T_{RM}) reaches a target temperature (T_{CAL}). The target temperature (T_{CAL}) may be application-specific based on the particular materials of construction of the rotor magnets 14, and the desired properties thereof based on magnetization curves associated with such materials. In one or more embodiments, lookup tables may be recorded in the memory 54 of FIG. 1 for access by the processor(s) 52 with corresponding target temperatures (T_{CAL}) for the second and third heating regions R2 and R3 of FIG. 5. Based on the current torque-speed operating point, the electronic controller 50 may extract a corresponding target temperature (T_{CAL}) and thereafter control the heating element 30 of FIG. 3 or its various alternative embodiments in a closed-loop until the rotor magnet temperature (T_{RM}) reaches the target temperature (T_{CAL}). The method 100 thereafter proceeds to block B107.

Block B107 (“EOC?”) includes determining, via the electronic controller 50 of FIG. 1, whether the low-load state of the PM motor 12 has ended. Continuing with the exemplary case of the motor vehicle 18, where the low-load state is cruise mode, block B107 includes determining whether the torque-speed operating point indicates an end of or terminal stage of the cruise mode, i.e., EOC. The method 100 proceeds to block B108 when the low-load state of the PM motor 12 has ended. The method 100 otherwise repeats blocks B106 and B107 in the alternative until the low-load state of the PM motor 12 has ended.

Block B108 (“DEC T_{RM}”) includes decreasing the temperature of the rotor magnets 14. As illustrated FIG. 5, for example, this would entail transitioning from the second heating region R2 to the first heating region R1. This may occur by discontinuing the heating process, as well as by introducing cooling, e.g., via circulation of the electrical coolant (CC_{C}) of FIGS. 3 and 4 around and/or through the rotor magnets 14 or the rotor shaft 120.

As noted above, preemptive cooling in anticipation of resuming a high-load operating mode, e.g., a launch mode or high-acceleration drive mode of the motor vehicle 18, may be beneficial when the rotor magnets 14 are constructed of rare earth materials. Likewise, the ability to look ahead during the low-load operating mode and accurately ascertain that the end the mode is imminent may be implementable in certain highly-repeatable drive profiles, e.g., of the exemplary train 18A, boat 18B, or airplane 18C of FIG. 1 in certain use cases. Various use cases of the motor vehicle 18 may exhibit similar drive profiles enabling prediction of the end of the low-load operating mode, e.g., when launching from a standstill or based on prevailing traffic conditions. The method 100 then proceeds to block B110.

At block B110 (“OPM=PM”), the method 100 includes performing the higher-load operating mode. In the exemplary case of the motor vehicle 18, for instance, this may entail performing a propulsion mode (PM) having higher torque/lower speed characteristics, e.g., the first or second heating regions R1 or R2 of FIG. 3. The method 100 then returns to block B102.

Among other benefits, the method 100 of FIG. 6 as set forth above enables selective heating of the rotor magnets 14 of FIGS. 1, 3, and 4 to control magnetic performance in a load-specific manner. The heating control strategy performed by the electronic controller 50 helps to reduce flux density in the PM motor 12, and consequently the core losses therein during low-load operating modes such as cruise mode. Due to the slow dynamic of cooling, aspects of the method 100 may be particularly useful in applications having predictable loads to prevent demagnetization in the event of sudden onset of a high load. The present teachings therefore address the potential problem of motor losses under relatively light loads and high operating speeds. These and other attended benefits for the present disclosure will be readily appreciated by those skilled in the art in view of the foregoing disclosure.

For purposes of this Detailed Description, unless specifically disclaimed: the singular includes the plural and vice versa; the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. An electric drive system, comprising:
a permanent magnet (PM) motor having a rotor;
one or more rotor magnets connected to the rotor;
a heating source connected to the one or more rotor magnets; and
an electronic controller in communication with the PM motor and the heating source, the electronic controller being programmed to selectively heat the one or more rotor magnets via the heating source during a predetermined low-load/high-speed operating mode of the electric drive system.

2. The electric drive system of claim 1, wherein the electronic controller is programmed to predict an impending high-load/low-speed operating mode, and to preemptively request cooling of the rotor magnets in response to the impending high-load/low-speed operating mode.

3. The electric drive system of claim 2, wherein the electronic controller is configured to preemptively request cooling of the rotor magnets by requesting a circulation of a pre-chilled electrical coolant around or through the rotor magnets.

4. The electric drive system of claim 2, wherein the rotor magnets are constructed of rare earth materials, and wherein the electronic controller is configured to preemptively request cooling of the rotor magnets constructed of the rare earth materials to thereby prevent demagnetization of the rotor magnets.

5. The electric drive system of claim 1, wherein the rotor magnets are constructed of ferrite such that the rotor magnets include ferrite magnets.

6. The electric drive system of claim 1, wherein the rotor includes a rotor yoke, and wherein the heating source includes a positive temperature coefficient (PTC) heating element disposed between the rotor yoke and the rotor magnets.

7. The electric drive system of claim 1, wherein the heating source includes a supply of pre-heated electrical coolant.

8. The electric drive system of claim 7 wherein the rotor includes a rotor shaft defining an axial fluid passage therein, the axial fluid passage being configured to conduct the pre-heated electrical coolant through the rotor shaft.

9. The electric drive system of claim 1, wherein the rotor is in fluid communication with pre-chilled electrical coolant, and the electronic controller is configured to request circulation of the pre-chilled electrical coolant around and/or through the rotor magnets to selectively cool the rotor magnets during a terminal stage of the predetermined low-load/high-speed operating mode.

10. The electric drive system of claim 1, further comprising:
an inverter circuit connected to the PM motor, wherein the electronic controller is configured to command pulse width modulation (PWM) harmonics via the inverter circuit, as part of the heating source, to thereby generate an eddy current within the rotor magnets at a level suitable for heating the rotor magnets.

11. A method for selectively heating a permanent magnet (PM) motor of an electric drive system, the PM motor having a plurality of rotor magnets connected to a rotor, the method comprising:
detecting a predetermined low-load/high-speed operating mode of the electric drive system via an electronic controller; and
selectively heating the rotor magnets during the predetermined low-load/high-speed operating mode via a heating source using the electronic controller.

12. The method of claim 11, further comprising:
predicting an impending high-load/low-speed operating mode of the electric drive system via the electronic controller; and
preemptively cooling the rotor magnets in response to the impending high-load/low-speed operating mode via a cooling source using the electronic controller.

13. The method of claim 11, wherein the heating source includes a resistive heating element, and wherein selectively heating the rotor magnets via the heating source includes activating the resistive heating element.

14. The method of claim 13, wherein the rotor includes a rotor yoke, and wherein activating the resistive heating element includes activating a positive temperature coefficient (PTC) heating element disposed between the rotor yoke and the rotor magnets.

15. The method of claim 11, wherein the heating source includes a supply of pre-heated electrical coolant, and wherein selectively heating the rotor magnets via the heating source includes circulating the pre-heated electrical coolant around or through the rotor magnets.

16. The method of claim 15, wherein the rotor includes a rotor shaft defining an axial fluid passage, and wherein selectively heating the rotor magnets via the heating source includes circulating the pre-heated electrical coolant through the axial fluid passage.

17. The method of claim 11, wherein the heating source includes an inverter circuit connected to the PM motor, the method further comprising:
commanding pulse width modulation harmonics via the inverter circuit using the electronic controller to thereby generate an eddy current within the rotor magnets; and
heating the rotor magnets using the eddy current.

18. A motor vehicle comprising:
a vehicle body;
a plurality of road wheels connected to the vehicle body; and
an electric drive system connected to the vehicle body, the electric drive system including:
a permanent magnet (PM) motor having a rotor connected to one or more of the road wheels, the rotor including a rotor yoke;
a plurality of rotor magnets connected to or integrated with the rotor;
a positive temperature coefficient heating element disposed between the rotor yoke and the rotor magnets; and
an electronic controller in communication with the PM motor and the positive temperature coefficient heating element, the electronic controller being configured to selectively heat the rotor magnets via the positive temperature coefficient heating element during a predetermined low-load/high-speed operating mode of the electric drive system.

19. The motor vehicle of claim 18, further comprising a supply of pre-chilled electrical coolant, wherein the electronic controller is configured to predict an impending high-load/low-speed operating mode of the motor vehicle, and to preemptively cool the rotor magnets using the pre-chilled electrical coolant in response to the impending high-load/low-speed operating mode, including commanding circulation of the pre-chilled electrical coolant through the PM motor.

20. The motor vehicle of claim 19, wherein the rotor includes a rotor shaft defining an axial fluid passage configured to conduct heated electrical coolant and/or the pre-chilled electrical coolant to heat and/or preemptively cool the rotor magnets, respectively.
